(19) United States
(12) Patent Application Publication
(10) Pub. No.: US 2025/0369578 A1
(43) Pub. Date: Dec. 4, 2025

(54) BRACKET SYSTEM FOR LIGHTING ASSEMBLIES

(71) Applicant: ERICO International Corporation, Solon, OH (US)

(72) Inventor: Michael Hung Sun Oh, Twinsburg, OH (US)

(21) Appl. No.: 19/222,244

(22) Filed: May 29, 2025

Related U.S. Application Data
(60) Provisional application No. 63/654,745, filed on May 31, 2024.

(51) Int. Cl. F21S 8/04

(52) U.S. Cl. CPC F21S 8/043

(57) ABSTRACT

A lighting system for a ceiling structure can include a support structure that includes a support section that supports a lighting assembly, and an attachment end connected to the support section. A mounting bracket that includes a support channel defined between first and second support members of the mounting bracket can be configured to slidably engage a ceiling member of the ceiling structure. The attachment end of the support structure can be secured to the mounting bracket. The mounting bracket can be attached to the ceiling member in an installed configuration, in which: a base of the ceiling member can support a ceiling covering against gravity; a stem of the ceiling member can extend upwardly from the base to be received into the support channel; and the mounting bracket can be seated on a top surface of the ceiling covering to support the support structure relative to the ceiling member.

### CROSS-REFERENCE TO RELATED APPLICATIONS

This application claims priority under 35 U.S.C. 119 from U.S. Provisional Application No. 63/654,745, filed May 31, 2024, titled “Bracket System For Lighting Assemblies,” which is incorporated herein by reference in its entirety.

### BACKGROUND

In many applications, it may be useful to secure lighting assemblies, electrical boxes and other components to ceiling structures or other members. Conventionally, mounting brackets are used to secure various support structures, which may support a lighting assembly, an electrical box or component, to ceiling members.

### SUMMARY

Some embodiments of the invention provide a method for securing a lighting assembly to a ceiling structure. The method can include providing a bracket system that includes a support structure. The support structure can include a support section that supports a lighting assembly of the lighting system, and an attachment end connected to the support section. The method can include securing the attachment end to a mounting bracket of the bracket system. The mounting bracket can include a support channel defined between first and second support members of the mounting bracket. The method can include attaching the mounting bracket to a ceiling member of the ceiling structure by sliding the mounting bracket onto the ceiling member to an installed configuration. In the installed configuration, a base of the ceiling member can support a ceiling covering against gravity. A stem of the ceiling member can extend upwardly from the base and can be received into the support channel. The mounting bracket can be seated on a top surface of the ceiling covering to support the support structure relative to the ceiling member.

Some embodiments of the invention provide a bracket system for securing a lighting assembly to a ceiling structure. The lighting system can include a support structure that includes a support section that supports a lighting assembly, and an attachment end connected to the support section. The lighting system can also include a mounting bracket that includes a support channel defined between first and second support members of the mounting bracket and can be configured to slidably engage a ceiling member of the ceiling structure. The attachment end of the support structure can be secured to the mounting bracket. The mounting bracket can be attached to the ceiling member in an installed configuration. In the installed configuration, a base of the ceiling member can support a ceiling covering against gravity. A stem of the ceiling member that extends upwardly from the base can be received into the support channel. The mounting bracket can be seated on a top surface of the ceiling covering to support the support structure relative to the ceiling member.

Some embodiments of the invention provide a method for installing a lighting system. The method can include securing a support structure to a mounting bracket of a bracket system. The mounting bracket can include a support channel defined between first and second support members. The method can include, with the support structure secured to the mounting bracket, attaching the mounting bracket to a ceiling member. This can be done by inserting a stem of the ceiling member into the support channel, and after inserting the stem into the support channel, moving the mounting bracket downward toward a base of the ceiling member that supports a ceiling covering, until the mounting bracket can be seated on the ceiling covering to support the support structure relative to the ceiling member.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an isometric view of a ceiling structure and a bracket system according to an embodiment of the invention, the bracket system including mounting brackets and a support structure, and the ceiling structure including ceiling members;

FIG. 2 is an exploded top isometric partial view of the bracket system and the ceiling structure of FIG. 1;

FIG. 3 is an isometric first-side view of an example mounting bracket of FIG. 1;

FIG. 4 is an axonometric second-side view of the mounting bracket of FIG. 3;

FIG. 5 is a side elevation view of the mounting bracket of FIG. 3;

FIG. 6A is a side elevation view of a bracket system including the bracket system and the support structure of FIG. 1, in a first orientation during an installation process, inverted relative to a second, installed orientation shown in FIG. 1;

FIG. 6B is an enlarged view of portion VIB of FIG. 6A;

FIG. 7A is a side elevation view of the bracket system of FIG. 1; and

FIG. 7B is an enlarged view of portion VIIB of FIG. 7A.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As noted above, in some contexts, it may be useful to secure or support components relative to certain structures. For example, electrical components, including lighting assemblies, may need to be mounted in a ceiling structure. Conventional mounting assemblies commonly use fasteners and mounting brackets to secure a support structure to areas of a ceiling structure. Using fasteners to secure a mounting bracket to a ceiling structure, however, can be undesirable because it can make installation difficult and less modifiable. Some conventional configurations have attempted to alleviate this problem by providing mounting brackets that can be secured to ceiling structures without fasteners, but these configurations often result in low retention strength. Securing conventional mounting brackets to support structures with fasteners is commonly a difficult, tedious task because stabilizing and supporting the structures during assembly is challenging due to their geometries. Additionally, securing brackets to specific portions of a ceiling structure (e.g., a bulb of a T-grid ceiling structure, discussed below) utilizing a fastener may be prohibited, limiting the use cases of conventional mounting brackets.

In some contexts, it may be useful to secure or support lighting assemblies specifically relative to T-grid ceiling structures, in which ceiling members typically include a base and a vertical stem extending upwardly from the base to a bulb. In different installations, the total length of the vertical stem may vary substantially. Accordingly, although some conventional brackets may securely engage a T-grid structure of certain stem lengths, these brackets may be less secure for other stem lengths. Therefore, contractors may be required to stock many different sizes of brackets to accommodate different sizes of T-grid stems, or may be forced to accept less secure attachment to some ceiling structures.

In the context of mounting lighting assemblies to ceiling structures, it may be important to properly align the lighting assemblies relative to a ceiling cover of the ceiling structure (e.g., ceiling tiles, hard lid covers, or other known ceiling covers). Unlike other components that may offer some degree of adjustability post-installation, lighting assemblies typically require precise positioning and alignment at the time of installation to meet both aesthetic and functional requirements. Specifically, certain building codes may require a front face of the lighting assembly to be installed flush with a downward facing surface of the ceiling cover (relative to gravity). As conventional lighting assemblies are generally not height-adjustable, the conventional lighting assemblies may extend a fixed distance (e.g., non-adjustable distance) from a bracket system. The fixed distance may correspond to common ceiling covering thicknesses (e.g., ½″, ⅝″, 1″, or any other common ceiling covering thickness), so that the front face of the lighting assemblies extending through ceilings cover are flush with the downward facing surface of the ceiling covers. However, conventional brackets may often be unsuitable to properly align lighting assemblies relative to the ceiling cover, especially in the context of T-grid structures that may have stems of varied lengths.

Embodiments of the invention can help alleviate these issues, and others. For example, embodiments of the invention may provide a mounting bracket for securing a support assembly, and in particular for securing a lighting assembly to ceiling structures. The mounting bracket can easily secure the support assembly to the support structures to support lighting assemblies or other devices relative to the building structures. Embodiments of the invention may also provide a mounting bracket that can be secured to a T-grid ceiling structure without additional hardware, such as screws or other loose fasteners, while providing enhanced retention over a variety of lengths of T-grid stems and thicknesses of ceiling covers.

Embodiments of the invention can include the mounting bracket that is mountable to a variety of different T-grid ceiling structures. For example, a support channel of the mounting bracket that receives a stem and bulb of a T-grid ceiling member can retain T-grid ceiling members having a plurality of different heights and configurations. In this regard, some examples may usefully be configured—and may correspondingly be installed-so that a mounting bracket that secures a lighting system to a T-grid ceiling member is seated on the material of the ceiling covering, rather than on the T-grid ceiling members itself. For example, as detailed in examples below, some brackets can be seated on a top surface of a ceiling tile that supported by the relevant T-grid ceiling member, while remaining spaced vertically apart from a base of the relevant T-grid ceiling member. Thus, for example, the mounting bracket can secure a lighting system (or other assembly) against being removed vertically from the T-grid ceiling member while also accommodating a wide range of T-grid stem heights due to the engagement of the bracket with the ceiling covering for support relative to gravity (e.g., rather than engagement with a support base the T-grid ceiling member).

In particular, some embodiments of the disclosed mounting bracket (and related support systems) can include a contact member that extends from support members that define a support channel. The contact member can be aligned to engage a ceiling covering of the T-grid ceiling structure in an installed configuration to support the mounting bracket (e.g., and an associated lighting system) when the support channel receives a stem of a T-grid (or other) ceiling member. Specifically, the contact member can be seated on a top surface of the ceiling covering to support the support assembly relative to the T-grid ceiling member and the ceiling covering. Seating the contact member on the top surface of the ceiling covering may advantageously secure the lighting assembly relative to the ceiling covering such that the front face of the lighting assemblies extends through the ceiling covering to be flush with the downward facing surface of the ceiling covering, regardless of the actual length of a T-grid stem in the relevant ceiling system.

Embodiments of the invention are presented below in the context of support structures or brackets intended to secure lighting assemblies to ceiling structures, including T-grid ceiling structures. Although these configurations can be particularly useful in some contexts, including due to the particular requirements for mounting lighting assemblies to ceiling structures, other configurations are possible. For example, the principles disclosed herein can be used with support structures intended to secure any variety of mountable components, including electrical boxes, vents, audio devices, fire alarms, and so on. Similarly, although some particular examples of T-grid structures are illustrated in the FIGS., some embodiments can be used with other T-grid structures (e.g., with taller or shorter stems, or differently configured bulbs) or otherwise.

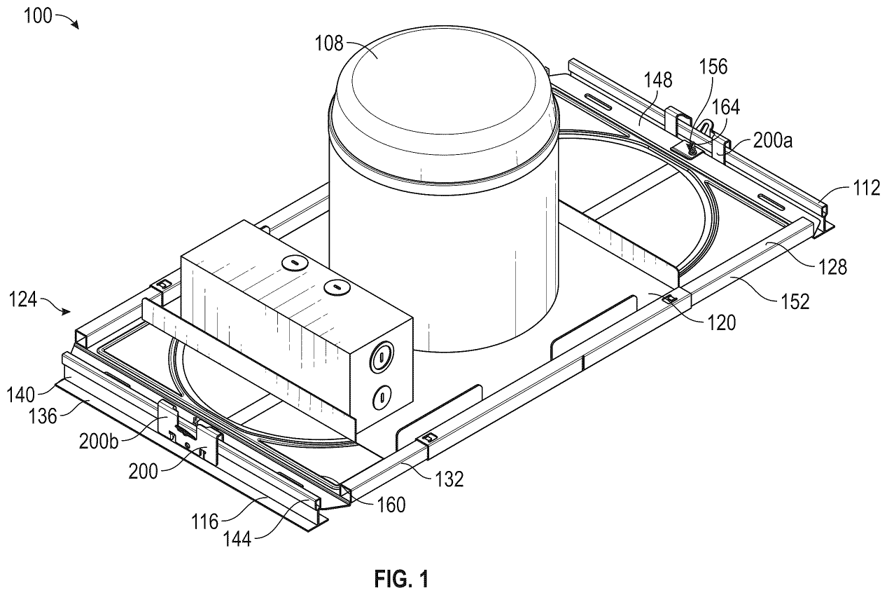

As noted above, embodiments of the present invention generally provide a bracket system for mounting and adjustably securing a light assembly or other object to a ceiling structure. FIG. 1 illustrates an example support assembly 100 configured to support various equipment 108 between a first and second building structure 112, 116. For example, as illustrated, the support assembly 100 can be part of a lighting system (e.g., a multi-piece lighting assembly) and the building structures 112, 116 can be tees of a T-grid ceiling or studs of a hard lid ceiling assembly, although other configurations are possible (e.g., with other supported equipment, other installation contexts, etc.).

In particular, the support assembly 100 can include a centerplate 120 configured to receive and retain the equipment 108. Additionally, the support assembly 100 can include a support bracket 124 that can be configured to support the centerplate 120 relative to the building structures 112, 116. In some examples, the support bracket 124 can be a telescopically adjustable bracket having a first bracket member 128 and a second bracket member 132. For example, the first bracket member 128 and the second bracket member 132 can be secured to the centerplate 120 and adjustable relative to the centerplate 120 to adjust an extension length of the support bracket 124, allowing the support assembly 100 to be secured between first and second building structures 112, 116 (e.g., T-grid ceiling members, as shown) that are spaced apart by various distances.

In the embodiment illustrated, the support assembly 100 is a telescoping ceiling bracket, however alternative structures or brackets may be used. For example, a support assembly could be any structure that includes one or more planar end portions that are configured to be received by a channel. Further, for example, a support assembly could be any structure having one or more flanged portions that can be inserted into a channel or slot. Further, a support portion of a support assembly, for example, can include any known type of configuration that is capable of supporting one or more lighting assemblies or other components. Therefore, mounting brackets according to embodiments of the present disclosure as described further below can be used to support or secure a variety of structures, including structures not expressly illustrated herein.

In some examples, the support assembly 100 can include mounting brackets to secure the support bracket 124 relative to the building structures 112, 116. For example, in the embodiment illustrated in FIG. 1, a pair of mounting brackets 200 can secure the bracket 124 to the building structures 112, 116. Although the support assembly 100 according to the present embodiment is illustrated with two of the mounting brackets 200, any number of mounting brackets may be used in other installations. For example, in some instances, the bracket system may include one, three, or four mounting brackets. Further, in some embodiments, sets of substantially identical mounting brackets can be used. However, in other embodiments, the mounting brackets may define one or more different characteristics, for example, one of the mounting brackets may be longer than another.

As will be described in greater detail herein, the support assembly 100 is configured so that it may be easily assembled prior to installation into a ceiling structure (e.g., onto the building structures 112, 116). Specifically, the support assembly can be assembled on a work bench or other surface before being attached to the building structures 112, 116. As also described further below, the mounting brackets 200 may be attached to the building structures 112, 116 without additional hardware, such as fasteners. Thus, the mounting brackets 200 can be removably secured to the building structures 112, 116 in some cases. Further, the support assembly 100 is generally provided to support the equipment 108 at a particular height relative to the building structures 112, 116 and a ceiling covering extending between the building structures 112, 116.

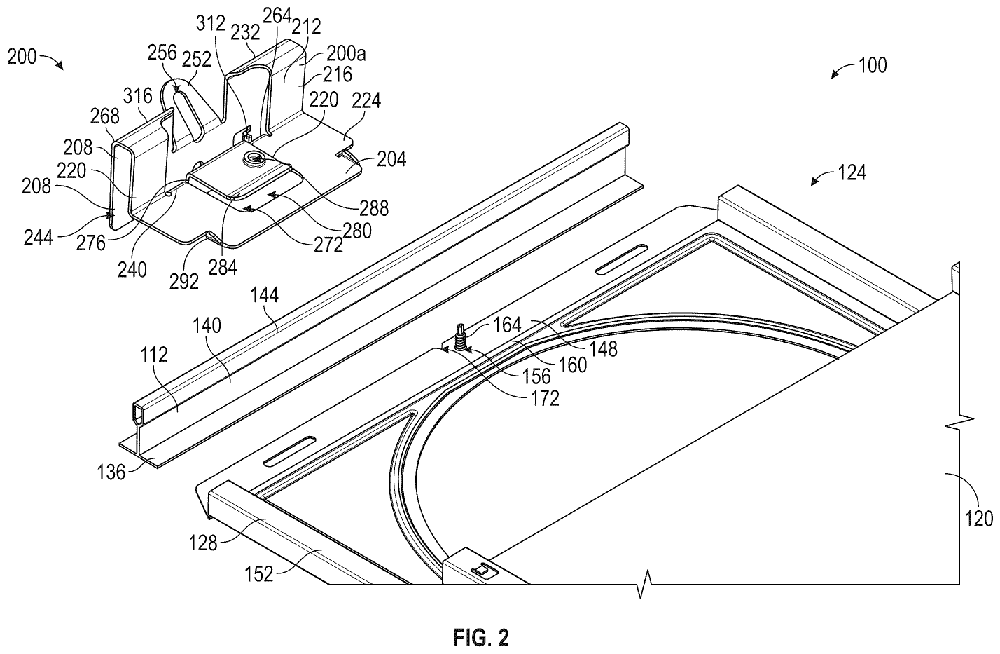

In different installations, mounting brackets according to embodiments of the invention can be readily secured to a variety of ceiling structures. For example, FIGS. 1 and 2 illustrate aspects of a particular configuration of the building structures 112, 116 that may be used with the mounting bracket 200 according to embodiments of the present disclosure. The illustrated mounting bracket 200 is provided for example purposes only, and other configurations are possible. Referring particularly to FIG. 2, in the embodiment illustrated, each of the building structures 112, 116 includes a flat base 136 and a stem 140. The stem 140 can extend from the flat base 136 to a widened top 144 (e.g., a bulb).

Specifically, the stem 140 can extend upward (relative to gravity) from the base 136. In some examples, the stem 140 can extend substantially perpendicularly from the flat base 136. However, in other examples, the stem 140 may extend obliquely from the flat base 136. In some examples, a height of the building structures 112, 116, measured between the base 136 and a distal end of the widened top 144 (e.g., opposite the base 136), can vary. As described further below, the mounting bracket 200 may be configured to accommodate the building structures 112, 116 of varying heights and configurations.

Although the building structures 112, 116 according to the present embodiment are T-grid ceiling members that include the stem 140 with the widened top 144, a variety of other configurations are possible. For example, the support assembly 100 according to the present invention may be configured to mount to any variety of a ceiling member or non-ceiling members. However, some embodiments may be particularly well suited for use with T-grid ceiling members, including due to the ability to accommodate a wide variety of heights of the vertical stems thereof.

Generally, support brackets according to the invention can include a variety of support rail configurations with ends that allow attachment to a mounting bracket. Returning to FIG. 1, the support bracket 124 according to the present embodiment is a ceiling bracket that includes a plurality of attachment ends 148 (e.g., two attachment ends). In some examples, the support bracket 124 can include a plurality of support rails 152 (e.g., two support rails). Furthermore, the attachment ends 148 of the support bracket 124 can connect the plurality of support rails 152. For example, the attachment ends 148 can connect the support rails 152 at opposite ends of attachment ends 148. Furthermore, the plurality of support rails 152 can extend substantially parallel to each other between the attachment ends 148. The support rails 152 can define a support section that is provided to support components, such as the centerplate 120 and the equipment 108. Further, in the embodiment illustrated, the plurality of support rails 152 can be telescoping (i.e., their lengths may be selectively adjusted), allowing the support assembly 100 to be telescopically adjusted; however alternative configurations are possible. In some examples, the attachment ends 148 can be symmetrical about the support rails 152, and, accordingly, the attachment ends 148 can share substantially identical aspects.

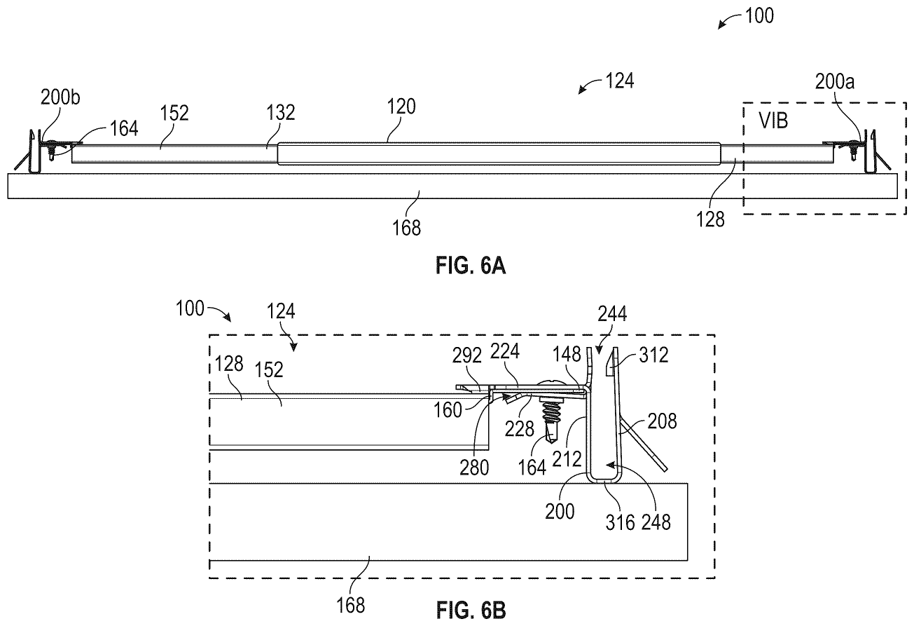

As best shown in FIG. 2, each of the attachment ends 148 (see also FIG. 6A) is a thin, elongate, planar section that is configured to be received by and secured to the mounting bracket 200. The attachment end 148 illustrated in FIG. 2, further includes a hole 156 that is configured to receive a fastener, such as a screw or a bolt, which will be described in greater detail below. Moreover, a shoulder 160 is disposed at a junction between each of the attachment ends 148 and the support section, e.g., the support rails 152. In some embodiments, the shoulder 160 may be used to secure the support backet 124 to the mounting bracket 200, an example of which will be described below. However, other configurations for support brackets, including their ends and support sections, are possible. For example, in some embodiments, ends of a support bracket may be non-planar or may not include a shoulder as shown in FIG. 2.

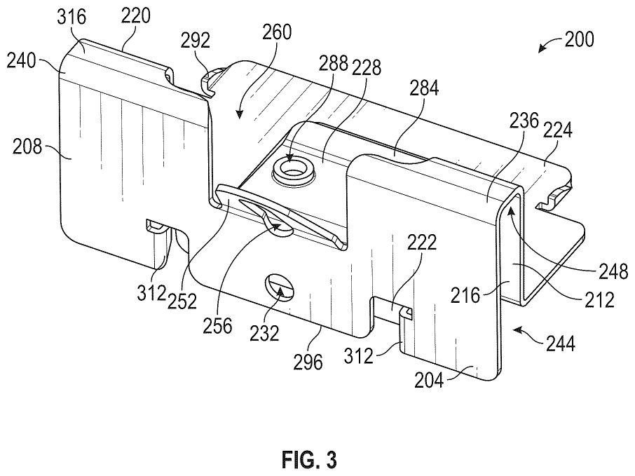

FIGS. 3-5 illustrate an example configuration of the mounting bracket 200 for use in the support assembly 100 of FIGS. 1 and 2 according to an embodiment of the invention. Referring to FIG. 3, the mounting bracket 200 is formed as a stamping from a single blank, which is bent to form a three-dimensional bracket body, although a variety of other approaches are possible. Accordingly, the mounting bracket 200 is integrally formed as a single unitary component. In some embodiments, a mounting bracket can be formed from spring steel. In some cases, spring steel may be particularly suitable, due to its high degree of elasticity and significant load strength. Furthermore, in some embodiments, a mounting bracket may be heat treated. For example, a mounting bracket can be formed from spring steel that is through hardened to enhance a hardness and tensile strength of the mounting bracket material. Other heat treatments may alternatively be used.

With continued reference to FIG. 3, the mounting bracket 200 has a bracket body 204 that includes a first support member 208 and a second support member 212. As described further below, the second support member 212 can extend from the first support member 208 to define a channel for receiving the building structures 112, 116. In some examples, the second support member 212 includes a first arm 216, a second arm 220, and a third arm 222. The first and second arms 216, 220 can extend from the first support member 208. Furthermore, a first contact member 224 and a second contact member 228 can extend from the second support member 212. For example, the first contact member 224 can extend from the first arm 216 and the second arm 220 and the second contact member 228 can extend from the third arm 222.

Again, each of the first support member 208, the second support member 212, the first arm 216, the second arm 220, the third arm 222, the first contact member 224, and the second contact member 228 can be integrally formed as part of a single component, and are a result of stamping and bending a blank material, e.g., spring steel. In different embodiments, different arrangements and geometries are possible for the components noted above.

Still referring to FIG. 3, the first support member 208 is planar, extending substantially along a single plane defined by the first support member 208. In the embodiment illustrated, the first support member 208 includes a hole 232 (e.g., for use as a locating feature during stamping operations), but other configurations are possible. For example, the hole 232 may receive a fastener (not shown) to secure the mounting bracket 200 to the building structures 112, 116.

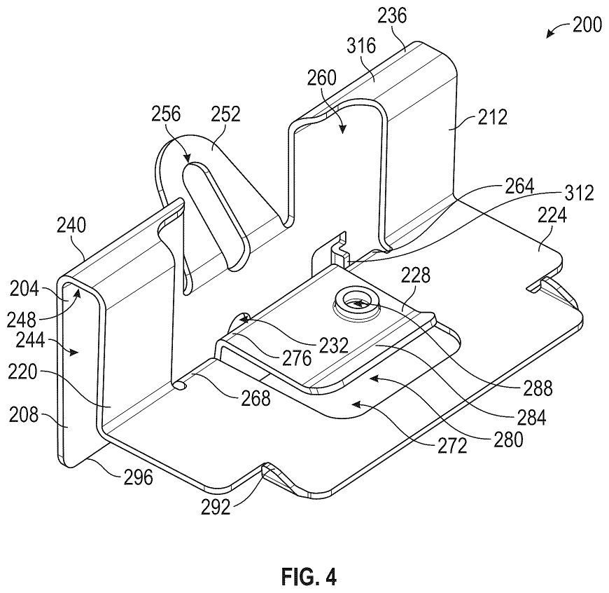

In some examples, the second support member 212 extends from a first edge 236 and a second edge 240 of the first support member 208. For example, as best seen in FIG. 4, the first arm 216 extends from the first edge 236 of the first support member 208. The first edge 236 can define a bend such that at least a portion of the first arm 216 extends along and adjacent to the first support member 208. The first edge 236 is generally a bend line that is formed by bending the first arm 216 relative to the first support member 208. Accordingly, the first edge 236 includes a radius of curvature, which may be between about 1.3 mm and 3.5 mm in some embodiments, but other configurations are possible.

Furthermore, as best seen in FIG. 4, the second arm 220 similarly extends from the second edge 240 of the first support member 208. The second edge 240 can define a bend such that at least a portion of the second arm 220 extends along and adjacent the first support member 208. Thus, the second edge 240 is generally a bend line that is formed by bending the second arm 220 relative to the first support member 208. The second edge 240 may have a radius of curvature between about 1.3 mm and 3.5 mm, but other configurations are possible. In some examples, the first edge 236 and the second edge 240 can be substantially collinear or coplanar.

In some examples, the second support member 212 can be planar. For example, the first arm 216 and the second arm 220 can extend parallel to one another and along a common plane. However, as described further below, the second support member 212 can include sections that are not co-planar with the arms 216, 220.

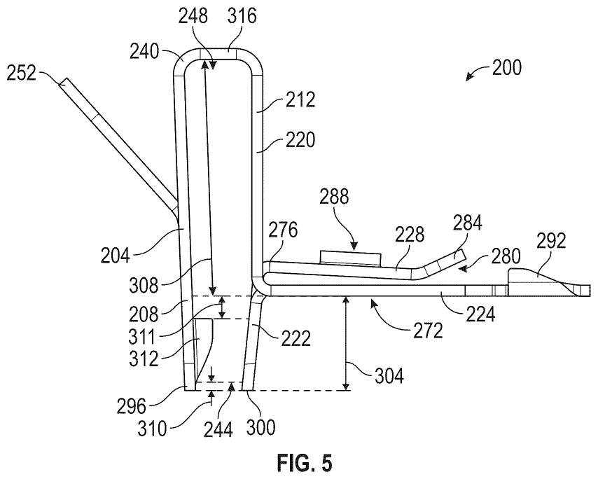

In some examples, the second support member 212 can extend substantially parallel to the first support member 208. For example, the second support member 212 can extend substantially parallel to the first support member 208 along a support channel 244 formed between the first support member 208 and the second support member 212. As described further below, the support channel 244 can extend from a blind end 248 (e.g., a connection between the first support member 208 and second support member 212) to free ends of the first and second support members 208, 212. In such examples, the second support member 212 can extend substantially parallel to the first support member 208 along between the first contact member 224 and the blind end 248 of a support channel 244. More specifically, referring to FIG. 5, in some embodiments, the first and second arms 216, 220 may extend substantially parallel to the first support member 208.

However, in other embodiments, the second support member 212 may extend obliquely relative to the first support member 208. For example, the first arm 216 and the first support member 208 may form an oblique angle (e.g., less than 5 degrees, less than 10 degrees, less than 20 degrees, or less than 30 degrees). Furthermore, the second arm 220 and the first support member 208 may form an oblique angle (e.g., less than 5 degrees, less than 10 degrees, less than 20 degrees, or less than 30 degrees). Additionally, the angle between the first arm 216 and the first support member 208 and the angle between the second arm 220 and the first support member 208 can be equal.

Still referring to FIG. 4, a tab 252 having a slot 256 can extend from the first support member 208 between the first and second arms 216, 220 and the first and second edges 236, 240. Generally, the slot 256 of the tab 252 is provided to receive cables or wires to bear the weight of a support structure and any component provided thereon, thereby decreasing loads on a ceiling structure (e.g., to comply with seismic regulations). While the tab 252 is integrally formed with the first support member 208 in the illustrated embodiment, tabs or elements for receiving cables or wires to bear the weight of the support structure or components may be individually fabricated and coupled to a bracket body in alternative embodiments. Further, while the tab 252 extends from the first support member 208 and is bent away from the first and second arms 216, 220 in the illustrated embodiment, other configurations are possible. For example, a mounting bracket may include a tab that is substantially coplanar with a first support member (i.e., extends substantially parallel to the plane of the first support member).

As described above, the contact members 224, 228 can extend from the second support member 212. In some examples, the first contact member 224 can be connected to the first and second edges 236, 240 of the first support member 208 by the first and second arms 216, 220. Therefore, via the second support member 212 (e.g., via the first and second arms 216, 220), the first contact member 224 can resiliently move relative to, yet remain connected to, the first support member 208.

The first contact member 224 can extend from the first and second arms 216, 220 of the second support member 212. More specifically, the first contact member 224 can be connected to the first and second arms 216, 220 by bend lines (e.g., made by stamping). Thus, the bend lines can be defined at a junction between the first contact member 224 and the first and second arms 216, 220. In some examples, the first contact member 224 can extend across an opening 260 defined between the first and second arms 216, 220 to connect the first and second arms 216, 220. In some examples, the opening 260 may be a stamped opening that substantially corresponds to the third arm 222, which will be described in greater detail below.

In the illustrated embodiment, for example, the first contact member 224 is planar, extending substantially along a single plane defined by the first contact member 224. In some examples, the first contact member 224 can extend substantially perpendicular (e.g., transverse) to the second support member 212 (e.g., the first and second arms 216, 220) or the first support member 208. For example, the plane defined by the first contact member 224 can extend substantially perpendicular to the second support member 212. Relatedly, and as discussed further below, the first contact member 224 (or the plan define thereby) can extend substantially perpendicular to an insertion direction of the building structures 112, 116 into the support channel 244, or may similarly extend substantially parallel with horizontal (e.g., substantially parallel to a supporting top surface of a ceiling covering).

The third arm 222 extends from third and fourth edges 264, 268 of the first contact member 224 in a direction opposite the first and second arms 216, 220. Generally, the third arm 222 corresponds to the stamped opening 260 defined between the first and second arms 216, 220. For example, the material blank can be stamped to define an outline of the stamped opening 260, which also corresponds to the third arm 222. Accordingly, the third arm 222 can be bent away from the first and second arms 216, 220 about the first contact member 224, thereby creating the stamped opening 272.

As described above, the second support member 212 can be planar. Referring to FIG. 5, in some embodiments the third arm 222 and may be substantially parallel to and may extend along a common plane as the first and second arms 216, 220. That is, the third arm 222 and the first and second arms 216, 220 may be bent away from each to form an angle of about 180 degrees. In such embodiments, the third arm 222 can extend parallel to the first support member 208, and an entirety of the second support member 212 may extend along a common plane.

In other examples, only sections of the second support member 212 may be planar. For example, the second support member 212 can be planar between the blind end 248 of the support channel 244 and the first contact member 224 (e.g., between the edges 236, 240 and the first contact member 224). Furthermore, the third arm 222 can extend obliquely relative to the first and second arms 216, 220. That is, the third arm 222 and the first and second arms 216, 220 may be bent away from each to form the angle between about 160 degrees and about 200 degrees or between about 170 degree and about 190 degrees. In such embodiments, the third arm 222 can extend obliquely relative to the first support member 208, and third arm 222 may not extend along plane that is common to the first and second arms 216, 220. Furthermore, in such embodiments, the third arm 222 can extend toward the first support member 208 to decrease a width of the support channel 244 (as described further below).

Returning to FIG. 4, the third and fourth edges 264, 268 are bend lines defined between the first contact member 224 and the third arm 222. In some examples, the third arm 222 can extend substantially perpendicularly from the first contact member 224 laterally between and vertically opposite the first and second arms 216, 220. However, in other examples, the third arm 222 may extend obliquely relative to the first contact member 224. For example, the third arm 222 and the first contact member 224 may be bent away from each to form the angle between about 70 degrees and about 90 degrees or between about 80 degrees and about 90 degrees.

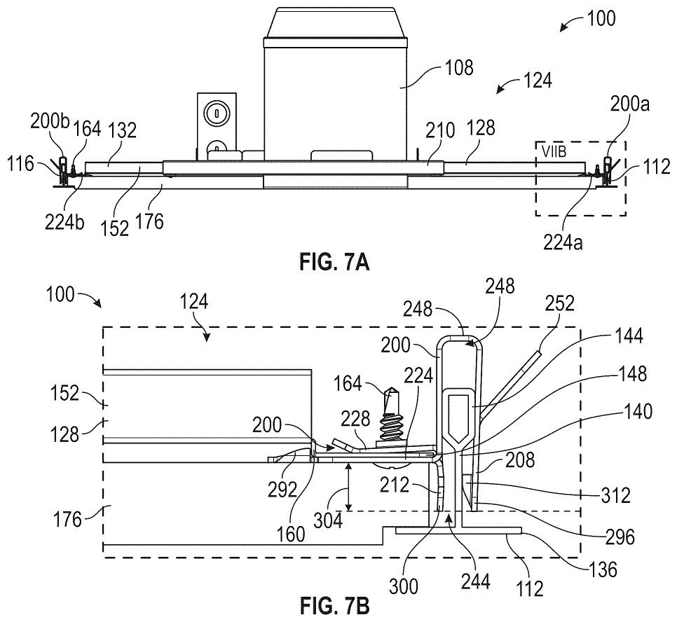

As described above, in the illustrated embodiment, as shown in FIG. 5 in particular, the first contact member 224 extends substantially perpendicularly to the support channel 244 for receiving the building structures 112, 116 (and substantially in parallel with a plane defined between free ends of the first and second support members 208, 212, as further discussed below). Accordingly, the first contact member 224 can extend substantially perpendicularly to a stem of a T-grid member (or substantially in parallel with a T-grid base) when installed (as shown in FIG. 7B). Thus, for example, the first contact member 224 can provide an extended horizontal support for a support structure that is supported by the mounting bracket 200.

Referring again to FIG. 4, as described above, the second contact member 228 can extend from the second support member 212. As described further below, in an installed configuration, the second contact member 228 can be positioned above the first contact member 224, relative to gravity. Consequently, in the installed configuration, the first contact member 224 can be the lower member of the contact members 224, 228 (e.g., and can correspondingly seat on a ceiling covering to support a larger lighting system).

As illustrated in FIG. 4, the second contact member 228 extends from a fifth edge 276 of the second support member 212, which is disposed between the third and fourth edges 264, 268 and, thus, the first and second arms 216, 220. Generally, the second contact member 228 corresponds to a stamped opening 272 defined along the first contact member 224. The second contact member 228 thus can be formed by bending a portion of material stamped from the first contact member 224 that results from the stamping of the stamped opening 272. More specifically, the second contact member 228 in the illustrated embodiment is defined by bending the material about the fifth edge 276, relative to the first contact member 224.

Although the second contact member 228 is generally elevated relative to the first contact member 224, it may still maintain alignment with the stamped opening 272. That is, the second contact member 228 may be at least partially aligned with a profile of the stamped opening 272 (sec, e.g., FIG. 4).

The second contact member 228 extends substantially along a single plane defined by the second contact member 228 from the fifth edge 276 in a direction similar to the first contact member 224. In some examples, the second contact member 228 may be substantially parallel to the first contact member 224. However, in other examples, the second contact member 228 can extend obliquely relative to the first contact member 224. For example, the second contact member 228 can extend at an angle that is less than about 20 degrees, less than about 10 degrees, or less than about 5 degrees relative to the first contact member 224.

As described above, the second contact member 228 is generally offset from the plane of the first contact member 224 (e.g., elevated above the first contact member 224, relative to gravity). The first and second contact members 224, 228 can therefore be spaced apart to define a contact channel 280 between the first and second contact members 224, 228.

The contact channel 280 generally extends between the first contact member 224 and the second contact member 228 to allow for insertion of a component to be secured to the bracket body 204 (e.g., the support bracket 124 of FIG. 2). Additionally, in the illustrated embodiment, the second contact member 228 includes a flared distal end 284. The flared distal end 284 may extend obliquely from the second contact member 228 in a direction that is away from the first contact member 224. In some cases, this configuration can further assist insertion of a component into the contact channel 280, by creating an enlarged entrance of the contact channel 280. However, other configurations are possible, including, but not limited to, configurations without an outwardly flared distal end.

Still referring to FIG. 5, the second contact member 228 is generally configured to move relative to, yet remain coupled to, the first contact member 224. Therefore, when (or as) a component, such as the support bracket 124 (e.g., the attachment end 148 as shown in FIG. 2) is inserted therebetween, the first and second contact members 224, 228 resiliently separate to receive the support bracket 124 into the contact channel 280. Furthermore, the contact members 224, 228 can resiliently clamp the inserted attachment end 148 within the contact channel 280 to secure the support bracket 124 relative to the mounting bracket 200. Thus, when the bracket 124 (e.g., the attachment end 148) is inserted between the first and second contact members 224, 228, the contact members 224, 228 may resiliently clamp the component therebetween, as can help to secure the component until a fastener, or other securing element, is added (and thereafter).

As described above, the second contact member 228 can extend from the fifth edge 276 to the distal end 284 toward the first contact member 224, at an oblique angle relative to the first contact member 224. In such examples, a width of the contact channel 280, measured perpendicular to the insertion direction of the support bracket 124 into the contact channel 280, may taper. For example, the contact channel 280 can define a maximum width proximate the fifth edge 276, and can decrease in width as the contact channel 280 extends toward the distal end 284; however, as described above, the contact channel 280 can again widen proximate the distal end 284.

In some examples, the second contact member 228 further includes a fastener attachment hole 288 that is sized to receive the body of a screw or other type of fastener. Therefore, the first and second contact members 224, 228 can be configured to hold an end of a component until a fastener is inserted into the hole 288. In the illustrated embodiment, the hole 288 is formed as part of an extruded feature that is integrally formed with the second contact member 228. In other embodiments, other configurations are possible. For example, some attachment features may include similar openings that are not included on an extrusion. In some embodiments, attachment features can include threaded openings, or can include non-threaded openings that provide sufficient contact area for suitable engagement by a self-tapping screw (e.g., an extrusion that is at least as thick as the feature from which it extends). As described further below, securing the attachment end 148 within the contact channel 280 of the mounting bracket 200 can include advancing a fastener through the opening 272 defined in the first contact member 224 and into the fastener attachment hole 288 defined in the second contact member 228.

Additionally, in the embodiment illustrated, the first contact member 224 further includes a pair of contact tabs 292. The pair of contact tabs 292 can be disposed proximate an end of the first contact member 224 that is opposite the second support member 212. Furthermore, the contact tabs 292 can extend away from the first contact member 224 in a direction toward the second contact member 228. The contact tabs 292 are generally provided to engage a component that is received within the contact channel 280 to help to secure the component within the contact channel 280. For example, as illustrated in FIG. 7B, the contact tabs 292 are configured to catch or contact portions of a bracket, such as, e.g., the shoulder 160 disposed at the end 148 of the support bracket 124. The contact tabs 292 may therefore engage the shoulder 160 to secure the attachment end 148 of the support bracket 124 within the contact channel 280. Although the present embodiment illustrates two contact tabs 292 (see, e.g., FIG. 4), other embodiments may include more, fewer, or no contact tabs, or may include tabs that are formed on a contact member other than at an edge thereof. Further, alternative embodiments may incorporate other elements, either integrally formed or separate, for securing or catching a portion of a component.

Referring again to FIG. 5, the first support member 208, the second support member 212 (e.g., the first arm 216 (not shown in FIG. 5), and the second arm 220, and the third arm 222), together define the support channel 244 which is configured to receive a structure, such as, e.g., the ceiling structure 112 of FIG. 2. The first support member 208 and the second support member 212 are configured so that the mounting bracket 200 can resiliently flex to allow insertion of components (e.g., the building structures 112, 116) into the support channel 244. The first and second support members 208, 212 may further resiliently engage and secure the inserted building structures 112, 116 within the support channel 244.

As described above, one or more of the arms 216, 220, 222 of the second support member 212 can extend at an oblique angle relative to the first support member 208. In such examples, a width of the support channel 244, measured perpendicular to the insertion direction of the building structures 112, 116 into the support channel 244, can taper between free ends of the first support member 208 and the second support member 212 (e.g., a free end of the third arm 222). For example, the support channel 244 can define a maximum width proximate the blind end 248 of the support channel 244, and can decrease in width as the support channel 244 extends toward the free ends of first and second support members 208, 212. Thus, when a component (e.g., the building structures 112, 116) is inserted between the first and second support members 208, 212, the support members 208, 212 may resiliently clamp the component therebetween. In other examples, the width of the support channel 244 may be the same between the blind end 248 and the first contact member 224, and may taper between the first contact member 224 and the free ends of the support members 208, 212 or the width may not taper at all.

In the embodiment illustrated, the free ends of the first support member 208 and the second support member 212 include a first free end 296 and a second free end 300, respectively. The free ends 296, 300 may define an entrance of the support channel 244 that is opposite the blind end 248 of the support channel 244. As illustrated in FIGS. 5 and 7B (e.g., the installed configuration), the free ends 296, 300 may be equally spaced from the blind end 248 of the support channel 244, relative to the insertion direction of components into the support channel 244. More specifically a distance between the first free end 296 and the blind end 248 is equal to a distance between the second free end 300 and the blind end 248. Additionally, and as described further below, a distance between the first contact member 224 and either (or both) of the first or second free ends 296, 300 (relative to the insertion direction) may be less than a distance between the first contact member 224 and the blind end 248 of the support channel 244.

As described further below, the first and second free ends 296, 300 may be supported above the base 136 of the building structures 112, 116 (as shown in FIG. 7B, in particular). In the illustrated embodiment, a plane of the first contact member 224 and the free ends 296, 300 of the support members 208, 212 may be separated by a vertical distance 304 that can be measured substantially perpendicular to the plane of the first contact member 224 or substantially parallel to the insertion direction of the building structures 112, 116 into the support channel 244. Furthermore, the distance 304 between the plane of the first contact member 224 and the first free end 296 may be equal to the distance 304 between the plane of the first contact member 224 and the second free end 300. In some examples, each of the first and second free ends 296, 300 may be spaced from the plane of the first contact member 224 by the distance 304 that is less than ⅜″. As will be described further below, the distance 304 being less than ⅜″ may ensure the first and second free ends 296, 300 do not contact the base 136 of the building structures 112, 116 upon installation (as shown in FIG. 7B). However, other configurations are possible.

In some embodiments, a vertical distance 308 between the blind end 248 of the support channel 244 and the first contact member 224, measured substantially perpendicular to the plane of the first contact member 224 or substantially parallel to the insertion direction of the building structures 112, 116 into the support channel 244, can be greater than the distance 304. For example, the distance 308 can be more than about 1.25 times, more than about 1.5 times, or more than about 2 times larger than the distance 304. Such examples may guarantee the support channel 244 is sufficiently long to support and retain the building structures 112, 116 of varying heights, while also ensuring the first and second free ends 296, 300 do not contact the base 136 of the building structures 112, 116 upon installation (as shown in FIG. 7B).

To further enhance retention, according to some embodiments, the first and second support members 208, 212 may include additional engagement features. In some examples, the first or second support member 208, 212 can include one or more engagement tabs 312. For example, the engagement tabs 312 can be disposed adjacent to the free ends 296, 300 of the support members 208, 212. Furthermore, the engagement tabs 312 can extend from the first or second support member 208, 212 into the support channel 244. The engagement tabs 312 are provided to catch or contact portions of the support structures 112, 116, such as, e.g., the widened top 144 or the stem 140 of the building structures 112, 116 shown in FIG. 7B. The engagement tabs 312 may therefore secure the building structures 112, 116 within the support channels 244 of the mounting bracket 200. For example, the engagement tabs 312 may prevent the removal of the building structures 112, 116 by engaging the widened top 144 of the building structures 112, 116 and preventing passage of the widened top 144 out of the support channel 244.

In the illustrated embodiment, the first support member 208 includes the engagement tabs 312 that extend inwardly into the support channel 244, in a direction toward the second support member 212. As shown in FIGS. 3 and 5, the engagement tabs 312 may be disposed adjacent the first free end 296. Specifically, the engagement tabs 312 may extend from the first free end 296, along the first support member 208, and at least partially toward the first edge 236. In the illustrated embodiment, the engagement tabs 312 may not extend further than the plane defined by the first contact member 224. Although the illustrated embodiment includes two engagement tabs 312 (see, e.g., FIG. 3), more or fewer (e.g., no) engagement tabs may be used on the support members 208, 212. Further, other configurations of engagement features may be used in alternative embodiments (e.g., with engagement tabs formed at different locations on either of the support members 208, 212).

Referring again to FIG. 5, as described above, the engagement tabs 312 can be disposed adjacent the free ends 296, 300 of the support members 208, 212. In such examples, a vertical distance 310 between the free ends 296, 300 of the support members 208, 212 and a portion of the engagement tabs 312 positioned closest to the free ends 296, 300, measured substantially perpendicular to the plane of the first contact member 224 or substantially parallel to the insertion direction of the building structures 112, 116 into the support channel 244, can be less than a vertical distance 311 measured parallel to the first distance 310 between the plane of the first contact member 224 and a portion of the engagement tabs 312 positioned closest to the first contact member 224. For example, the distance 310 can be more than about 1.25 times, more than about 1.5 times, or more than about 2 times smaller than the distance 311. Such examples may allow the engagement tabs 312 to engage the building structures 112, 116 at a location that is adjacent to the entrance of the support channel 244. Furthermore, such examples may allow for effective engagement with the building structures 112, 116 during insertion or installation, as in the installed configuration the engagement tabs 312 can be positioned below the widened top 144 before the building structures 112, 116 contact the blind end 248 of the support channel 244, allowing the support channel 244 to receive the building structures 112, 116 of various sizes and configurations. Furthermore, this positioning may allow the engagement tabs 312 to function as an initial retention mechanism that engages the widened top 144 of the building structures 112, 116 early in the insertion process. By being closer to the free ends 296, 300, the engagement tabs 312 may provide immediate resistance and feedback to an installer to communicate that the building structures 112, 116 are received within the support channel 244.

Turning to FIGS. 6A and 6B, as mentioned above, the mounting bracket 200 is configured to allow for easy installation of a support assembly for a lighting assembly or other component. For example, the mounting bracket 200 is configured to slide onto the attachment end 148 of the support bracket 124. In the illustrated embodiment, the mounting bracket 200 can be slid onto the support bracket 124 so that the contact channel 280 receives the attachment end 148 until the contact tabs 292 pass over the shoulder 160 of the support bracket 124. For example, the first contact member 224 may extend beyond the shoulder 160, whereas the second contact member 228 may end before the shoulder 160. Accordingly, the contact tabs 292 can engage the shoulder 160, thereby preventing unintentional disconnection of the mounting bracket 200 and the support bracket 124. Because the first and second contact members 224, 228 of the mounting bracket 200 are configured to clamp the support bracket 124 (as also discussed above), and the contact tabs 292 are configured to retain the end 148 within the contact channel 280 via engagement with the shoulder 160, the mounting bracket 200 securely holds the support bracket 124 in place until a fastener (e.g., screw 164) is installed (as needed). In some examples, the support bracket 124 (e.g., the attachment end 148) can be attached to the mounting brackets 200 before the mounting brackets 200 are attached to the building structures 112, 116. As described further below, installing the mounting brackets 200 onto the support bracket 124 before attaching the mounting brackets 200 to the building structures 112, 116 can beneficially simplify the assembly of the support assembly 100.

In some examples, mounting brackets 200a, 200b, as instances of the mounting bracket 200, and the support bracket 124 extending between the mounting brackets 200a, 200b can be stably supported by a support surface, such as, e.g., a work bench 168, while the screw 164 is being inserted. In some examples, the first and second arms 216, 220 of the mounting brackets 200 can each include a flat section 316 that creates a base on which the mounting bracket 200, and the support bracket 124 can be stabilized. For example, the flat sections 316 can be formed along the first and second edges 236, 240 adjacent the blind end 248 of the support channel 244. The flat sections 316 of the mounting brackets 200a, 200b can contact and be stabilized by the work bench 168, such that the mounting brackets 200a, 200b rest on the work bench 168 inverted. Therefore, in an instance where two mounting brackets 200a, 200b are being attached to the support bracket 124 (e.g., to stage the support bracket 124 for installation), as shown in FIGS. 6A and 6B, the mounting brackets 200a, 200b can support and balance the support bracket 124, as well as the centerplate 120, extending between the mounting brackets 200a, 200b in an inverted position during staging (e.g., while the screws 164 are being attached thereto). In some embodiments, a centerplate such as the centerplate 120 can be installed on or between the support rails 152 of the support bracket 124 prior to staging, during staging, or prior to installation of the mounting brackets 200a, 200b onto a ceiling structure.

In the illustrated orientation, due to the configuration of the first and second contact members 224, 228, including the hole 288 and the opening 272, a user can easily align and then secure the support bracket 124 to the mounting brackets 200 with hand tools and screws. Thus, the screws 164 may be installed when the mounting brackets 200 and the support structure are in a staged configuration, as shown in FIGS. 6A and 6B. Generally, a “staging” of a support structure can include a variety of operations in which the support structure is secured to other components or otherwise arranged for easier installation, before being actually attached in a final location (e.g., attached to a ceiling grid).

In the illustrated example, as generally illustrated in FIGS. 3-6B, the flat sections 316 themselves can extend within a common plane when secured to a common support structure (e.g., the support bracket 124). Correspondingly, the flat sections 316 and can provide a stable base for support of the mounting bracket 200 during an installation process (see, e.g., FIGS. 6A and 6B, in which the common plane extends along the work bench 168). In some embodiments, first and second arms (or other features) may provide similar structures that extend within a common plane to provide support for a larger assembly, in an inverted orientation, during an installation process, but that are not necessarily flat (e.g., that include support ribs or other protrusions). In some embodiments, such a common plane (e.g., as shown in FIG. 5) may extend in parallel with one or more of a plane defined by a contact channel (or one or more contact members) or a plane defined by free ends of support members, so that mounting brackets at opposing ends of a generally planar support structure can stably support the support structure during an installation process (e.g., as shown in FIGS. 6A and 6B) with the support structure in a horizontal orientation.

In some examples, securing the attachment end 148 within the contact channel 280 of the mounting bracket 200 can include advancing the screws 164 through the opening 272 defined in the first contact member 224, through the hole 156 in the attachment end 148, and into the fastener attachment hole 288 defined in the second contact member 228. In some installations, a separate threaded nut may be secured to the fastener. In some installations, however, a threaded nut may be integral with the mounting bracket, e.g., with the second contact member 228, as part of a fastener attachment structure. Once the assembly is completed, and the support bracket 124 and mounting brackets 200 are fully (or otherwise) staged for installation (e.g., secured to one another as shown in FIGS. 6A and 6B), the entire assembly can be transported together, then inverted and slid into engagement with a ceiling structure (e.g., as shown in FIGS. 1, 7A, and 7B).

In the embodiment illustrated, each of the screws 164 (and, accordingly, the hole 288 shown in FIG. 4), is offset to accommodate features of the support bracket 124. Specifically, returning to FIG. 2, the illustrated support bracket 124 includes a notch 172 at each end 148 thereof. Thus, as best seen in FIG. 1, the screw 164 is offset to help to preserve maximum structural integrity of the support bracket 124. In other embodiments, however, similar holes and corresponding screws may be positioned to accommodate any number of design features. Additionally, while the mounting bracket 200 according to the illustrated embodiment uses a single fastener to secure the support bracket 124 within the contact channel 280, other configurations are possible. For example, more or fewer fasteners may be used. Additionally or alternatively, other embodiments may incorporate different features, such as, e.g., pins, latches, clamps, adhesives, or the like, to removably or permanently secure a mounting bracket to a support structure.

In some embodiments, before an assembly such as is shown in FIGS. 6A and 6B is attached to a building structure (or at various times thereafter), further hardware can be secured thereto. For example, the equipment 108 can be secured to the staged assembly shown in FIGS. 6A and 6B before the support assembly 100 is installed onto the building structures 112, 116.

FIGS. 7A and 7B illustrate a side elevation view of the pair of the mounting brackets 200a, 200b, that are coupled to the support bracket 124 in an upright orientation (i.e., as inverted relative to the orientation shown in FIGS. 6A and 6B for the mounting brackets 200) as can facilitate collective, simultaneous installation onto a T-grid ceiling. The mounting brackets 200a, 200b may be secured to ceiling members, such as, e.g., the building structures 112, 116. For example, the mounting brackets 200a, 200b are configured to slide (e.g., snap) onto the building structures 112, 116. Specifically, the support channel 244 of each mounting bracket 200 is configured to receive the stem 140 of the corresponding building structure 112, 116 so that the first support member 208 and the second support member 212 are disposed on opposing sides of the stem 140. After inserting the stems 140 of the building structures 112, 116 into the support channels 244, the mounting brackets 200a, 200b can be moved downward (relative to gravity) toward the base 136 of the building structures 112, 116. As described further below, the building structures 112, 116 support a ceiling covering, and the mounting brackets 200a, 200b can be moved downward to be seated on the ceiling covering to support the support assembly 100 relative to the ceiling covering and the building structure 112, 116.

As discussed above, the screws 164 coupling the support bracket 124 of the mounting brackets 200a, 200b can be installed while the mounting brackets 200a, 200b and the support bracket 124 are in the inverted position, while being staged for installation (see, e.g., FIGS. 6A and 6B). Therefore, when the mounting brackets 200a, 200b and the support bracket 124 are upright, such as when installed on the building structures 112, 116, the screws 164 are inverted so that a head of the screw 164 is disposed below a body of the screw 164, relative to gravity. This configuration may prevent the screws 164 from interfering with other ceiling components, such as, e.g., a ceiling covering 176 (e.g., ceiling tile or other known ceiling covering). Similarly, the balanced configuration of the mounting brackets, to stably support a larger assembly in an inverted orientation before final installation, can allow screws to be easily installed in the noted beneficial orientation.

As illustrated in FIGS. 7A and 7B, the ceiling covering 176 may be mounted on the building structures 112, 116. Specifically, edges of the ceiling covering 176 may contact and be supported against gravity by an upward facing surface of the bases 136 of the building structures 112, 116. Furthermore, the mounting brackets 200a, 200b may be mounted to the ceiling members such that a downward facing surface (e.g., relative to gravity) of the first contact members 224a, 224b of the mounting brackets 200a, 200b is seated on the ceiling covering 176 (e.g., resting on a top surface of the ceiling covering 176 relative to gravity). The ceiling covering 176 may therefore support the mounting brackets 200a, 200b, the support bracket 124, and the equipment 108. As discussed above, the mounting brackets 200a, 200b may also be supported by drop wires coupled to the tabs 252.

Embodiments of the invention can help to ensure support of the equipment 108 (or other equipment) at an appropriate height relative to the ceiling covering 176. For example, in the illustrated configuration, when the first contact members 224a, 224b contact the ceiling covering 176, the support assembly 100 may advantageously be “laid down” on the ceiling covering 176, so that the centerplate 120 of the support assembly 100 can contact, or can be close to contacting, the ceiling covering 176. As described above, the equipment 108 may be configured to extend a fixed distance from a downward facing surface (e.g., relative to gravity) of the centerplate 120. As illustrated in FIG. 7A, “laying down” the support bracket 124 on the ceiling covering 176 may allow a front of the equipment 108 to be flush with the bottom surface of the ceiling covering 176. Specifically, the front of the equipment 108 that extends the fixed distance (e.g., ⅜″) from the centerplate 120 may extend through the ceiling covering 176 having a thickness of ⅜″, and may be flush with the bottom surface of the ceiling covering 176. However, as described above, the equipment 108 can extend different distances from the centerplate 120 to accommodate different thicknesses of the ceiling covering 176.

As described above, the first and second free ends 296, 300 of the first support member 208 and the second support member 212 may be spaced from the first contact member 224 by the distance 304 that is less than ⅜″. Generally, a minimum distance between an upward facing surface of the ceiling covering 176 (e.g., relative to gravity) and the upward facing surface of the bases 136 of the building structures 112, 116, on which the ceiling covering 176 is mounted, is greater than or equal to ⅜″ (e.g., may be ⅜″, ½″, ⅝″, 1″, or any other common distance). As such, the distance 304 measured between the plane of the first contact member 224 and the first and second free ends 296, 300 being less than ⅜″ may ensure the first and second free ends 296, 300 of the first support member 208 and the second support member 212 do not contact the upward facing surface of the base 136 of the ceiling member 176. As such, in the installed configuration, the free ends 296, 300 of the first and second support members 208, 212 are disposed above and spaced vertically apart from the base 136 of the building structures 112, 116 (relative to gravity). For example, the free ends 296, 300 of the first and second support members 208, 212 can be separated from the base 136 of the building structures 112, 116 by a vertical gap. Consequently, as the engagement tabs 312 are disposed adjacent to the free ends 296, 300 of the support members 208, 212, the engagement tabs 312 can be spaced vertically apart from, and above, the base 136 of the building structures 112, 116 (relative to gravity).

Correspondingly, the distance 304 being less than ⅜″ may also ensure that the first contact member 224 can contact the ceiling covering 176 to “lay down” the bracket system 102 on the ceiling covering 176 without interference caused by the first and second free ends 296, 300 of the first support member 208 and the second support member 212 contacting the base 136.

The support bracket 124 is generally configured to support components, such as the equipment 108 and the centerplate 120. Support structures in other embodiments may be configured to support more, fewer, or different components than the ones illustrated in the present embodiment. In some embodiments, the centerplate 120 may be configured to adjustably support the equipment 108 relative to the building structures 112, 116. For example, the centerplate 120 may be slidably adjustable along a length of the support bracket 124. Thus, embodiments of the invention can provide improved mounting systems for securing lighting assembles, electrical boxes or other components, including relative to T-grid ceiling structures. In some embodiments, for example, an improved mounting system according to the invention may be easily assembled and require few fasteners or added hardware. Thus, for example, it may be relatively easy to install and use mounting systems according to embodiments of the present invention.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

In some implementations, devices or systems disclosed herein can be utilized or installed using methods embodying aspects of the invention. Correspondingly, description herein of particular features or capabilities of a device or system is generally intended to inherently include disclosure of a method of using such features for intended purposes and of implementing such capabilities. Similarly, express discussion of any method of using a particular device or system, unless otherwise indicated or limited, is intended to inherently include disclosure, as embodiments of the invention, of the utilized features and implemented capabilities of such device or system.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise specified or limited, directional terms are presented only with regard to the particular embodiment and perspective described. For example, reference to features or directions as “horizontal,” “vertical,” “front,” “rear,” “left,” “right,” and so on are generally made with reference to a particular figure or example and are not necessarily indicative of an absolute orientation or direction. However, relative directional terms for a particular embodiment may generally apply to alternative orientations of that embodiment. For example, “front” and “rear” directions or features (or “right” and “left” directions or features, and so on) may be generally understood to indicate relatively opposite directions or features.

While the structures and components disclosed herein may be embodied in many different forms, several specific embodiments are discussed herein with the understanding that the embodiments described in the present disclosure are to be considered only exemplifications of the principles described herein, and the disclosure is not intended to be limited to the embodiments illustrated. Throughout the disclosure, the terms “about” and “approximately” mean plus or minus 5% of the number that each term precedes, inclusive. Similarly, as used herein with respect to a reference value, the term “substantially equal” (and the like) refers to variations from the reference value of less than ±5% (e.g., ±2%, ±1%, ±0.5%) inclusive.

Unless otherwise limited or defined, “substantially parallel” indicates a direction that is within ±12 degrees of a reference direction (e.g., within ±6 degrees or ±3 degrees), inclusive. Correspondingly, “substantially vertical” indicates a direction that is substantially parallel to the vertical direction, as defined relative to gravity, with a similarly derived meaning for “substantially horizontal” (relative to the horizontal direction). Likewise, unless otherwise limited or defined, “substantially perpendicular” indicates a direction that is within ±12 degrees of perpendicular a reference direction (e.g., within ±6 degrees or ±3 degrees), inclusive. Likewise, unless otherwise limited or defined, “substantially radial” indicates a direction that is within ±12 degrees of radial a reference direction (e.g., within ±6 degrees or ±3 degrees), inclusive. Likewise, unless otherwise limited or defined, “substantially axial” indicates a direction that is within ±12 degrees of axial a reference direction (e.g., within ±6 degrees or ±3 degrees), inclusive.

Also as used herein, unless otherwise limited or defined, “substantially identical” indicates that features or components are manufactured using the same processes according to the same design and the same specifications. In some cases, substantially identical features can be geometrically congruent.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

What is claimed is:

1. A method for securing a lighting system to a ceiling structure, the method comprising:
providing a bracket system that includes a support structure, the support structure including a support section that supports a lighting assembly of the lighting system; and an attachment end connected to the support section;
securing the attachment end to a mounting bracket of the bracket system, the mounting bracket including a support channel defined between first and second support members of the mounting bracket; and
attaching the mounting bracket to a ceiling member of the ceiling structure by sliding the mounting bracket onto the ceiling member to an installed configuration,
in the installed configuration:
a base of the ceiling member supporting a ceiling covering against gravity;
a stem of the ceiling member extending upwardly from the base and being received into the support channel; and
the mounting bracket being seated on a top surface of the ceiling covering to support the support structure relative to the ceiling member.

2. The method of claim 1, wherein, in the installed configuration, free ends of the first and second support members are above and spaced vertically apart from the base of the ceiling member.

3. The method of claim 1, wherein securing the attachment end to the mounting bracket includes inserting the attachment end of the support structure into a contact channel of the mounting bracket that is defined between first and second contact members of the first mounting bracket, the first and second contact members being resiliently movable relative to one another to resiliently receive the attachment end into the contact channel; and
wherein, in the installed configuration a lower one of the first and second contact members is seated on the top surface of the ceiling covering to support the support structure relative to the ceiling member.

4. The method of claim 3, wherein securing the attachment end to the mounting bracket further includes advancing a fastener through the lower one of the first and second contact members to secure the attachment end within the contact channel.

5. The method of claim 1, wherein the stem of the ceiling member supports a bulb opposite the base of the ceiling member;
wherein the first and second support members are resiliently movable relative to each other to resiliently secure the stem within the support channel, and a free end of one or more of the first support member or the second support member, respectively, includes a tab extending into the support channel; and
wherein, in the installed configuration, the tab extends toward the stem of the ceiling member, to prevent passage of the bulb out of the support channel.

6. The method of claim 5, wherein, in the installed configuration, the tab is above and spaced vertically apart from the base of the ceiling member.

7. The method of claim 1, wherein the attachment end is secured to the mounting bracket before the mounting bracket is attached to the ceiling member by sliding the mounting bracket onto the ceiling member to the installed configuration.

8. A lighting system for a ceiling structure, the lighting system comprising:
a support structure that includes a support section that supports a lighting assembly, and an attachment end connected to the support section; and
a mounting bracket that includes a support channel defined between first and second support members of the mounting bracket and is configured to slidably engage a ceiling member of the ceiling structure, the attachment end of the support structure being secured to the mounting bracket;
the mounting bracket being attached to the ceiling member in an installed configuration, in which:
a base of the ceiling member supports a ceiling covering against gravity;
a stem of the ceiling member that extends upwardly from the base is received into the support channel; and
the mounting bracket is seated on a top surface of the ceiling covering to support the support structure relative to the ceiling member.

9. The lighting system of claim 8, wherein, in the installed configuration, a vertical gap is defined between a free end of each the first and second support members, respectively, and the base of the ceiling member.

10. The lighting system of claim 8, wherein the attachment end of the support structure is received into a contact channel of the mounting bracket that is defined between first and second contact members of the first mounting bracket, the first and second contact members being resiliently movable relative to one another to resiliently receive the attachment end into the contact channel; and
wherein, in the installed configuration, a lower one of the first and second contact members is seated on the top surface of the ceiling covering to support the support structure relative to the ceiling member.

11. The lighting system of claim 10, wherein the attachment end is further secured to the mounting bracket by a fastener that extends through the lower one of the first and second contact members to secure the attachment end within the contact channel.

12. The lighting system of claim 10, wherein a vertical distance between the lower one of the first and second contact members and a free end of the first support member is less than a vertical distance between the lower one of the first and second contact members and a blind end of the support channel.

13. The lighting system of claim 8, wherein the stem of the ceiling member supports a widened end opposite the base of the ceiling member;
wherein the first and second support members are resiliently movable relative to each other to resiliently secure the stem within the support channel, and a free end of one or more of the first support member or the second support member, respectively, includes a tab extending into the support channel; and
wherein, in the installed configuration, the tab extends toward the stem of the ceiling member, to prevent passage of the widened end out of the support channel.

14. The lighting system of claim 13, wherein, in the installed configuration, the tab is above and spaced vertically apart from the base of the ceiling member.

15. The lighting system of claim 13, wherein a vertical distance between the tab and the free end of the one or more of the first support member or the second support member is less than a distance between the tab and a lower contact member of the mounting bracket that engages the attachment end of the support structure.

16. The lighting system of claim 8, wherein the mounting bracket is stamped from a single piece of material.

17. The lighting system of claim 8, wherein, in the installed configuration, free ends of the first and second support members are equally spaced in a vertical direction from a blind end of the support channel.

18. A method for installing a lighting system, the method comprising:
securing a support structure to a mounting bracket of a bracket system, the mounting bracket including a support channel defined between first and second support members; and
with the support structure secured to the mounting bracket, attaching the mounting bracket to a ceiling member by:
inserting a stem of the ceiling member into the support channel; and
after inserting the stem into the support channel, moving the mounting bracket downward toward a base of the ceiling member that supports a ceiling covering, until the mounting bracket is seated on the ceiling covering to support the support structure relative to the ceiling member.

19. The method of claim 18, wherein in an installed configuration, free ends of the first support member and the second support member are separated from the base of the ceiling member by a vertical gap.

20. The method of claim 19, wherein securing the support structure to the mounting bracket includes securing the support structure to a contact member of the mounting bracket that extends transverse to the first and second support members; and
wherein, in the installed configuration, a vertical distance between the contact member and the free ends of the first support member and the second support member is less than a vertical distance between the contact member and a blind end of the support channel.
